(19) United States
(12) Patent Application Publication
(10) Pub. No.: US 2025/0034299 A1
(43) Pub. Date: Jan. 30, 2025

(54) METHOD FOR PREPARING OLEFIN-BASED POLYMER AND OLEFIN-BASED POLYMER PRODUCED USING THE SAME

(71) Applicant: HANWHA SOLUTIONS CORPORATION, Seoul (KR)

(72) Inventors: Munhee LEE, Daejeon (KR); Ui Gap JOUNG, Daejeon (KR); Jeong Hyun PARK, Daejeon (KR); Sung Dong KIM, Daejeon (KR); Jisong JO, Daejeon (KR); Junho SEO, Daejeon (KR); Seongjae LIM, Daejeon (KR); Hye Ran PARK, Daejeon (KR); Daegak KIM, Daejeon (KR)

(73) Assignee: HANWHA SOLUTIONS CORPORATION, Seoul (KR)

(21) Appl. No.: 18/690,138

(22) PCT Filed: Aug. 29, 2022
(86) PCT No.: PCT/KR2022/012879

§ 371 Date: Mar. 7, 2024

(30) Foreign Application Priority Data
Sep. 7, 2021 (KR) 10-2021-0118898

(51) Int. Cl. C08F 210/16

(52) U.S. Cl. CPC C08F 210/16; C08F 2420/03

(57) ABSTRACT

Provided are a method for preparing an olefin-based polymer and an olefin-based polymer produced using the same. The method for preparing an olefin-based polymer according to an exemplary embodiment may adjust processability of the olefin-based polymer produced using the method by a polymerization temperature. In addition, the method for preparing an olefin-based polymer according to the exemplary embodiment may adjust drop impact strength of a finally obtained film by a polymerization temperature.

### TECHNICAL FIELD

The present invention relates to a method for preparing an olefin-based polymer and an olefin-based polymer produced using the same. Specifically, the present invention relates to a method for preparing an olefin-based polymer of which the processability may be adjusted by a polymerization temperature, and an olefin-based polymer produced using the same.

### BACKGROUND ART

A metallocene catalyst is one of the catalysts used in olefin polymerization, which is a compound in which a ligand such as cyclopentadienyl, indenyl, or cycloheptadienyl is coordinated to a transition metal or a transition metal halogen compound, and has a sandwich structure as a basic form.

A Ziegler-Natta catalyst which is another catalyst used for polymerizing olefins has an active site having heterogeneous properties, since a metal component as the active site is dispersed on an inert solid surface; however, the metallocene catalyst is known as a single-site catalyst having identical polymerization properties in all active sites, since it is one compound having a certain structure. A polymer polymerized with the metallocene catalyst as such has a narrow molecular weight distribution, a uniform comonomer distribution, and copolymerization activity higher than the Ziegler Natta catalyst.

Meanwhile, a linear low-density polyethylene (LLDPE) is produced by copolymerizing ethylene and α-olefin at a low pressure using a polymerization catalyst, has a narrow molecular weight distribution and a short chain branch (SCB) having a certain length, and does not have a long chain branch (LCB) in general. A film produced with a linear low-density polyethylene has high breaking strength and elongation, and excellent tear strength, impact strength, and the like, together with general properties of polyethylene, and thus, is widely used in a stretch film, an overlap film, and the like to which it is conventionally difficult to apply low-density polyethylene or high-density polyethylene.

However, the linear low-density polyethylene produced by a metallocene catalyst has poor processability due to the narrow molecular weight distribution, and a film produced therefrom tends to have lowered heat seal properties.

Therefore, a method for preparing an olefin-based polymer of which the processability may be adjusted as needed is being demanded.

### DISCLOSURE

### Technical Problem

An object of the present invention is to provide a method for preparing an olefin-based polymer of which the processability may be adjusted by a polymerization temperature.

Another object of the present invention is to provide an olefin-based polymer produced using the above production method.

### Technical Solution

In one general aspect, a method for preparing an olefin-based polymer includes: polymerizing an olefin-based monomer at a polymerization temperature of 70 to 90° C. in the presence of a hybrid catalyst including at least one first transition metal compound represented by the following Chemical Formula 1 and at least one second transition metal compound selected from a compound represented by the following Chemical Formula 2 and a compound represented by the following Chemical Formula 3, thereby obtaining an olefin-based polymer, wherein the olefin-based polymer has (1) a density of 0.915 to 0.935 g/cm³; (2) a melt index (MI_{2.16}) of 0.5 to 1.5 g/10 min as measured with a load of 2.16 kg at 190° C.; and (3) a ratio (melt flow ratio; MFR) between a melt index (MI_{21.6}) measured with a load of 21.6 kg and a melt index (MI_{2.16}) measured with a load of 2.16 kg at 190° C. satisfying the following Equation 1:

$$- 0.4 T + 53.7 < MFR < - 0.4 T + 55.7 \qquad [ Equation 1 ]$$

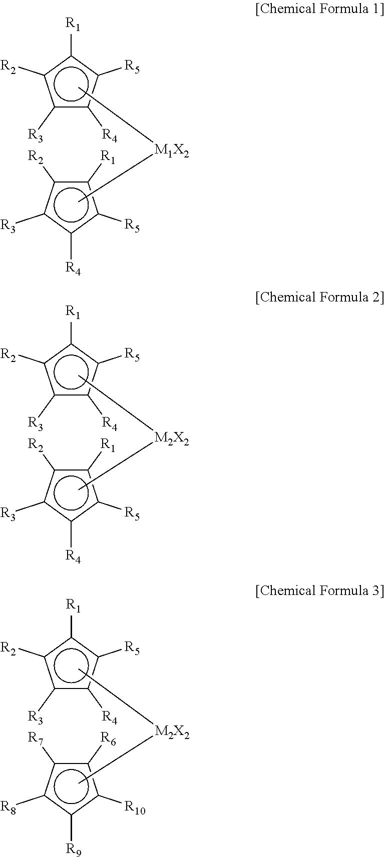

wherein MFR is a melt flow ratio, T is a polymerization temperature (° C.),
M₁ and M₂ are different from each other and independently of each other titanium (Ti), zirconium (Zr), or hafnium (Hf),
X is independently of each other halogen, C₁₋₂₀ alkyl, C₂₋₂₀ alkenyl, C₂₋₂₀ alkynyl, C₆₋₂₀ aryl, C₁₋₂₀ alkyl C₆₋₂₀ aryl, C₆₋₂₀ aryl C₁₋₂₀ alkyl, C₁₋₂₀ alkylamido, or C₆₋₂₀ arylamido, and
R₁ to R₁₀ are independently of one another hydrogen, substituted or unsubstituted C₁₋₂₀ alkyl, substituted or unsubstituted C₂₋₂₀ alkenyl, substituted or unsubstituted C₆₋₂₀ aryl, substituted or unsubstituted C₁₋₂₀ alkyl C₆₋₂₀ aryl, substituted or unsubstituted C₆₋₂₀ aryl C₁₋₂₀ alkyl, substituted or unsubstituted C₁₋₂₀ heteroalkyl, substituted or unsubstituted C₃₋₂₀ heteroaryl, substituted or unsubstituted C₁₋₂₀ alkylamido, substituted or unsubstituted C₆₋₂₀ arylamido, substituted or unsubstituted C₁₋₂₀ alkylidene, or substituted or unsubstituted C₁₋₂₀ silyl, but R₁ to R₁₀ may be independently of one another connected to an adjacent group to form a substituted or unsubstituted saturated or unsaturated C₄₋₂₀ ring.

In a specific example of the present invention, M₁ and M₂ may be different from each other and be zirconium or hafnium, respectively, X may be halogen or C₁₋₂₀ alkyl, respectively, and R₁ to R₁₀ may be hydrogen, substituted or unsubstituted C₁₋₂₀ alkyl, substituted or unsubstituted C₂₋₂₀ alkenyl, or substituted or unsubstituted C₆₋₂₀ aryl, respectively.

In a preferred specific example of the present invention, M₁ may be hafnium, M₂ may be zirconium, and X may be chlorine or methyl.

In a preferred specific example of the present invention, the first transition metal compound may be at least one of transition metal compounds represented by the following Chemical Formulae 1-1 and 1-2, and the second transition metal compound may be at least one of transition metal compounds represented by the following Chemical Formulae 2-1, 2-2, and 3-1:

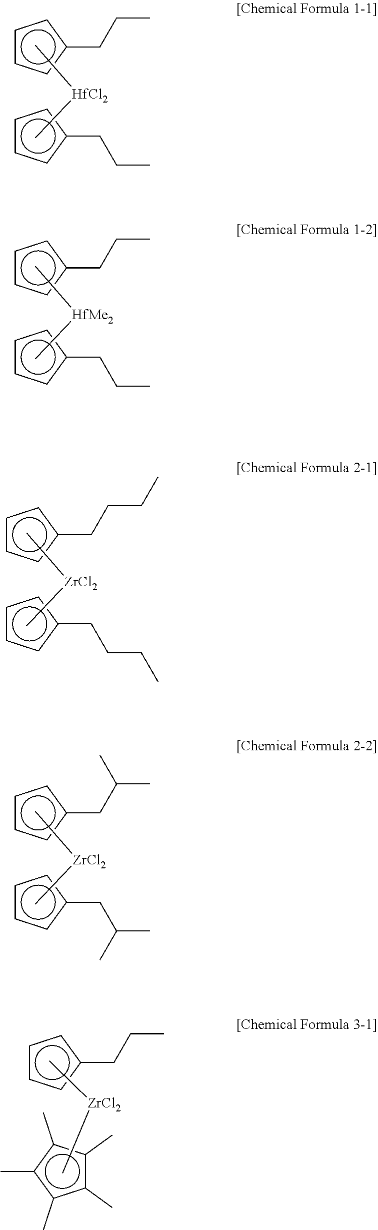

wherein Me is a methyl group.

In a specific example of the present invention, a mole ratio of the first transition metal compound to the second transition metal compound is in a range of 100:1 to 1:100.

In a specific example of the present invention, the catalyst may further include at least one cocatalyst compound selected from the group consisting of a compound represented by the following Chemical Formula 4, a compound represented by the following Chemical Formula 5, and a compound represented by Chemical Formula 6:

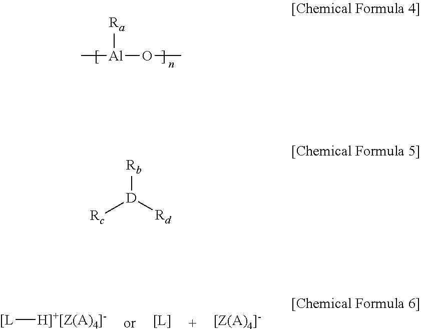

wherein n is an integer of 2 or more, Rₐ is a halogen atom, a C₁₋₂₀ hydrocarbon group, or a C₁₋₂₀ hydrocarbon group substituted with halogen,
D is aluminum (Al) or boron (B), R_{b}, R_{c}, and R_{d} are independently of one another a halogen atom, a C₁₋₂₀ hydrocarbon group, a C₁₋₂₀ hydrocarbon group substituted with halogen, or a C₁₋₂₀ alkoxy group,
L is a neutral or cationic Lewis base, [L-H]⁺ and [L]⁺ are a Bronsted acid, Z is a group 13 element, and A is independently of each other a substituted or unsubstituted C₆₋₂₀ aryl group or a substituted or unsubstituted C₁₋₂₀ alkyl group.

In a specific example of the present invention, the catalyst may further include a carrier which supports a transition metal compound, a cocatalyst compound, or both of them.

In a preferred specific example of the present invention, the carrier may include at least one selected from the group consisting of silica, alumina, and magnesia.

Herein, a total amount of the transition metal compound supported on the carrier may be 0.001 to 1 mmol based on 1 g of the carrier, and a total amount of the cocatalyst compound supported on the carrier may be 2 to 15 mmol based on 1 g of the carrier.

In a specific example of the present invention, the olefin-based polymer may be a copolymer of an olefin-based monomer and an olefin-based comonomer. Specifically, the olefin-based monomer may be ethylene, and the olefin-based comonomer may be at least one selected from the group consisting of propylene, 1-butene, 1-pentene, 4-methyl-1-pentene, 1-hexene, 1-heptene, 1-octene, 1-decene, 1-undecene, 1-dodecene, 1-tetradecene, and 1-hexadecene. Preferably, the olefin-based polymer may be a linear low-density polyethylene in which the olefin-based monomer is ethylene and the olefin-based comonomer is 1-hexene.

In a specific example of the present invention, polymerization of the olefin-based monomer may be performed by gas phase polymerization, and specifically, the polymerization of the olefin-based monomer may be performed in a gas phase fluidized bed reactor.

In another general aspect, an olefin-based polymer which is produced by the above production method, and has (1) a density of 0.915 to 0.935 g/cm³; and (2) a melt index (MI_{2.16}) of 0.5 to 1.5 g/10 min as measured with a load of 2.16 kg at 190° C. is provided.

In a specific example of the present invention, the olefin-based polymer may have (1) the density of 0.915 to 0.925 g/cm³; and (2) the melt index of 0.8 to 1.2 g/10 min as measured with a load of 2.16 kg at 190° C.

In a specific example of the present invention, a film produced from the olefin-based polymer may have a drop impact strength (unit: g) satisfying the following Equation 2 as measured in accordance with ASTM D1709 based on a thickness of 50 μm:

$$- 1.8 {T}^{2} + 275 T - 9830 < drop impact strength < - 1.8 {T}^{2} + 275 T - 9730 \qquad [ Equation 2 ]$$

wherein T is a polymerization temperature (° C.).

### Advantageous Effects

The method for preparing an olefin-based polymer according to an exemplary embodiment of the present invention may adjust processability of the olefin-based polymer by a polymerization temperature.

### DESCRIPTION OF DRAWINGS

FIG. 1 is a graph showing a change in MFR depending on a polymerization temperature in a method for preparing an olefin-based polymer according to an exemplary embodiment of the present invention.

FIG. 2 is a graph showing a change in drop impact strength depending on a polymerization temperature in a method for preparing an olefin-based polymer according to an exemplary embodiment of the present invention.

### BEST MODE

Hereinafter, the present invention will be described in more detail.

### Method for Preparing Olefin-Based Polymer

According to an exemplary embodiment of the present invention, a method for preparing an olefin-based polymer includes: polymerizing an olefin-based monomer at a polymerization temperature of 70 to 90° C. in the presence of a hybrid catalyst including at least one first transition metal compound represented by the following Chemical Formula 1 and at least one second transition metal compound selected from a compound represented by the following Chemical Formula 2 and a compound represented by the following Chemical Formula 3, thereby obtaining an olefin-based polymer, wherein the olefin-based polymer has (1) a density of 0.915 to 0.935 g/cm³; (2) a melt index (MI_{2.16}) of 0.5 to 1.5 g/10 min as measured with a load of 2.16 kg at 190° C.; and (3) a ratio (melt flow ratio; MFR) between a melt index (MI_{21.6}) measured with a load of 21.6 kg and a melt index (MI_{2.16}) measured with a load of 2.16 kg at 190° C. satisfying the following Equation 1:

$$- 0.4 T + 53.7 < MFR < - 0.4 T + 55.7 \qquad [ Equation 1 ]$$

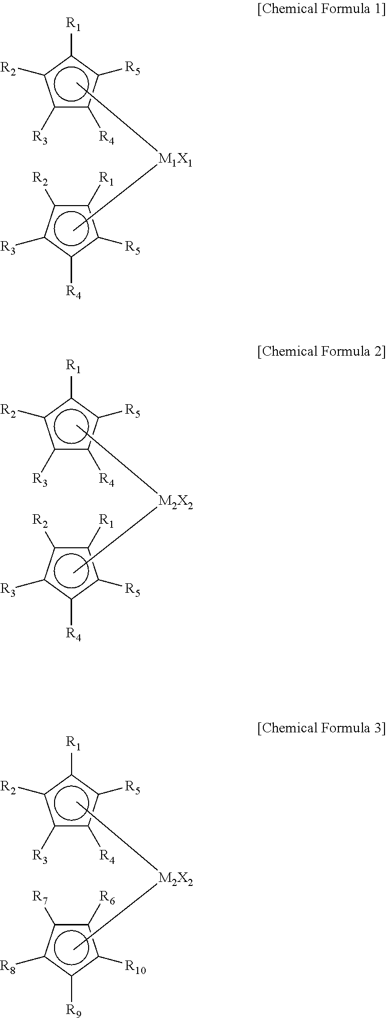

wherein MFR is a melt flow ratio, T is a polymerization temperature (° C.), and
M₁ and M₂ are different from each other and independently of each other titanium (Ti), zirconium (Zr), or hafnium (Hf). Specifically, M₁ and M₂ may be different from each other and be zirconium or hafnium, respectively. Preferably, M₁ may be hafnium and M₂ may be zirconium.

X may be independently of each other halogen, C₁₋₂₀ alkyl, C₂₋₂₀ alkenyl, C₂₋₂₀ alkynyl, C₆₋₂₀ aryl, C₁₋₂₀ alkyl C₆₋₂₀ aryl, C₆₋₂₀ aryl C₁₋₂₀ alkyl, C₁₋₂₀ alkylamido, or C₆₋₂₀ arylamido. Specifically, X may be halogen or C₁₋₂₀ alkyl, respectively. Preferably, X may be chlorine or methyl.

R₁ to R₁₀ may be independently of one another hydrogen, substituted or unsubstituted C₁₋₂₀ alkyl, substituted or unsubstituted C₂₋₂₀ alkenyl, substituted or unsubstituted C₆₋₂₀ aryl, substituted or unsubstituted C₁₋₂₀ alkyl C₆₋₂₀ aryl, substituted or unsubstituted C₆₋₂₀ aryl C₁₋₂₀ alkyl, substituted or unsubstituted C₁₋₂₀ heteroalkyl, substituted or unsubstituted C₃₋₂₀ heteroaryl, substituted or unsubstituted C₁₋₂₀ alkylamido, substituted or unsubstituted C₆₋₂₀ arylamido, substituted or unsubstituted C₁₋₂₀ alkylidene, or substituted or unsubstituted C₁₋₂₀ silyl, but R₁ to R₁₀ may be independently of one another connected to an adjacent group to form a substituted or unsubstituted saturated or unsaturated C₄₋₂₀ ring. Specifically, R₁ to R₁₀ may be hydrogen, substituted or unsubstituted C₁₋₂₀ alkyl, substituted or unsubstituted C₂₋₂₀ alkenyl, or substituted or unsubstituted C₆₋₂₀ aryl, respectively.

In a specific example of the present invention, M₁ and M₂ may be different from each other and be zirconium or hafnium, respectively, X may be halogen or C₁₋₂₀ alkyl, respectively, and R₁ to R₁₀ may be hydrogen, substituted or unsubstituted C₁₋₂₀ alkyl, substituted or unsubstituted C₂₋₂₀ alkenyl, or substituted or unsubstituted C₆₋₂₀ aryl, respectively.

In a preferred specific example of the present invention, M₁ may be hafnium, M₂ may be zirconium, and X may be chlorine or methyl.

In a preferred specific example of the present invention, the first transition metal compound may be at least one of transition metal compounds represented by the following Chemical Formulae 1-1 and 1-2, and the second transition metal compound may be at least one of transition metal compounds represented by the following Chemical Formulae 2-1, 2-2, and 3-1:

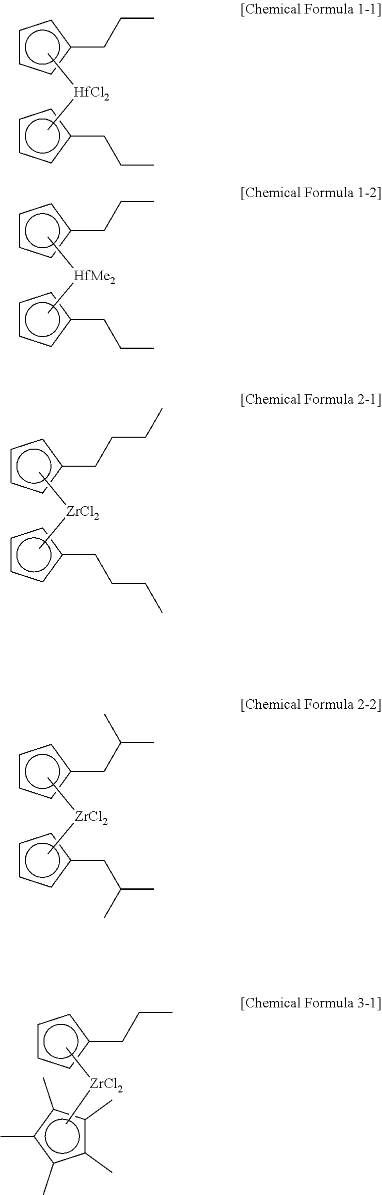

wherein Me is a methyl group.

In a specific example of the present invention, a mole ratio of the first transition metal compound to the second transition metal compound is in a range of 100:1 to 1:100. Preferably, the mole ratio of the first transition metal compound to the second transition metal compound is in a range of 50:1 to 1:50. More preferably, the mole ratio of the first transition metal compound to the second transition metal compound is in a range of 10:1 to 1:10.

In a specific example of the present invention, the catalyst may further include at least one cocatalyst compound selected from the group consisting of a compound represented by the following Chemical Formula 4, a compound represented by the following Chemical Formula 5, and a compound represented by Chemical Formula 6:

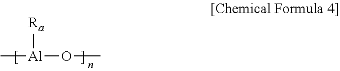

wherein n is an integer of 2 or more, Rₐ is a halogen atom, C₁₋₂₀ hydrocarbon, or C₁₋₂₀ hydrocarbon substituted with halogen. Specifically, Rₐ may be methyl, ethyl, n-butyl, or isobutyl.

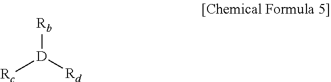

wherein D is aluminum (Al) or boron (B), and R_{b}, R_{c}, and R_{d} are independently of one another a halogen atom, a C₁₋₂₀ hydrocarbon group, a C₁₋₂₀ hydrocarbon group substituted with halogen, or a C₁₋₂₀ alkoxy group. Specifically, when D is aluminum (Al), R_{b}, R_{c}, and R_{d} may be independently of one another methyl or isobutyl, and when D is boron (B), R_{b}, R_{c}, and R_{d} may be pentafluorophenyl, respectively.

[L-H]⁺[Z(A)₄]⁻or [L]+[Z(A)₄]⁻ [Chemical Formula 6]
wherein L is a neutral or cationic Lewis base, [L-H]⁺ and [L]⁺ are a Bronsted acid, Z is a group 13 element, and A is independently of each other a substituted or unsubstituted C₆₋₂₀ aryl group or a substituted or unsubstituted C₁₋₂₀ alkyl group. Specifically, [L-H]⁺ may be dimethylanilinium cation, [Z(A)₄]⁻ may be [B(C₆F₅)₄]⁻, and [L]⁺ may be [(C₆H₅)₃C]⁺.

Specifically, an example of the compound represented by Chemical Formula 4 includes methylaluminoxane, ethylaluminoxane, isobutylaluminoxane, butylaluminoxane, and the like, and is preferably methylaluminoxane, but is not limited thereto.

An example of the compound represented by Chemical Formula 5 includes trimethylaluminum, triethylaluminum, triisobutylaluminum, tripropylaluminum, tributylaluminum, dimethylchloroaluminum, triisopropylaluminum, tri-s-butylaluminum, tricyclopentylaluminum, tripentylaluminum, triisopentylaluminum, trihexylaluminum, trioctylaluminum, ethyldimethylaluminum, methyldiethylaluminum, triphenylaluminum, tri-p-tolylaluminum, dimethylaluminummethoxide, dimethylaluminumethoxide, trimethylboron, triethylboron, triisobutylboron, tripropylboron, tributylboron, and the like, and is preferably trimethylaluminum, triethylaluminum, and triisobutylaluminum, but is not limited thereto.

An example of the compound represented by Chemical Formula 6 includes triethylammoniumtetraphenylboron, tributylammoniumtetraphenylboron, trimethylammoniumtetraphenylboron, tripropylammoniumtetraphenylboron, trimethylammoniumtetra(p-tolyl)boron, trimethylammoniumtetra(o,p-dimethylphenyl)boron, tributylammoniumtetra(p-trifluoromethylphenyl)boron, trimethylammoniumtetra(p-trifluoromethylphenyl)boron, tributylammoniumtetrapentafluorophenylboron, N,N-diethylaniliniumtetraphenylboron, N,N-diethylaniliniumtetrapentafluorophenylboron, diethylammoniumtetrapentafluorophenylboron, triphenylphosphoniumtetraphenylboron, trimethylphosphoniumtetraphenylboron, triethylammoniumtetraphenylaluminum, tributylammoniumtetraphenylaluminum, trimethylammoniumtetraphenylaluminum, tripropylammoniumtetraphenylaluminum, trimethylammoniumtetra(p-tolyl)aluminum, tripropylammoniumtetra(p-tolyl)aluminum, triethylammoniumtetra(o,p-dimethylphenyl)aluminum, tributylammoniumtetra(p-trifluoromethylphenyl)aluminum, trimethylammoniumtetra(p-trifluoromethylphenyl)aluminum, tributylammoniumtetrapentafluorophenylaluminum, N,N-diethylaniliniumtetraphenylaluminum, N,N-diethylaniliniumtetrapentafluorophenylaluminum, diethylammoniumtetrapentatetraphenylaluminum, triphenylphosphoniumtetraphenylaluminum, trimethylphosphoniumtetraphenylaluminum, tripropylammoniumtetra(p-tolyl)boron, triethylammoniumtetra(o,p-dimethylphenyl)boron, triphenylcarboniumtetra(p-trifluoromethylphenyl)boron, triphenylcarboniumtetrapentafluorophenylboron, and the like.

In a specific example of the present invention, the catalyst may further include a carrier which supports a transition metal compound, a cocatalyst compound, or both of them. Specifically, the carrier may support both the transition metal compound and the cocatalyst compound.

Herein, the carrier may include a material containing a hydroxyl group on the surface, and preferably, may use a material having highly reactive hydroxyl group and siloxane group which is dried to remove moisture from the surface. For example, the carrier may include at least one selected from the group consisting of silica, alumina, and magnesia. Specifically, silica, silica-alumina, silica-magnesia, and the like which are dried at a high temperature may be used as the carrier, and these may usually contain oxide, carbonate, sulfate, and nitrate components such as Na₂O, K₂CO₃, BaSO₄, and Mg(NO₃)₂. In addition, these may include carbon, zeolite, magnesium chloride, and the like. However, the carrier is not limited thereto, and is not particularly limited as long as it may support a transition metal compound and a cocatalyst compound.

The carrier may have an average particle size of 10 to 250 μm, preferably 10 to 150 μm, and more preferably 20 to 100 μm.

The carrier may have a micropore volume of 0.1 to 10 cc/g, preferably 0.5 to 5 cc/g, and more preferably 1.0 to 3.0 cc/g.

The carrier may have a specific surface area of 1 to 1,000 m²/g, preferably 100 to 800 m²/g, and more preferably 200 to 600 m²/g.

In a preferred specific example of the present invention, the carrier may be silica. Herein, a drying temperature of the silica may be 200 to 900° C. The drying temperature may be 300 to 800° C., and more preferably 400 to 700° C. When the drying temperature is lower than 200° C., silica has too much moisture so that the moisture on the surface reacts with the cocatalyst compound, and when the drying temperature is higher than 900° C., the structure of the carrier may collapse.

A concentration of a hydroxyl group in dried silica may be 0.1 to 5 mmol/g, preferably 0.7 to 4 mmol/g, and more preferably 1.0 to 2 mmol/g. When the concentration of the hydroxyl group is less than 0.1 mmol/g, the supported amount of a first cocatalyst compound is lowered, and when the concentration is more than 5 mmol/g, the catalyst component becomes inactive.

The total amount of the transition metal compound supported on the carrier may be 0.001 to 1 mmol based on 1 g of the carrier. When a ratio between the transition metal compound and the carrier satisfies the above range, appropriate supported catalyst activity is shown, which is advantageous in terms of the activity maintenance and economic feasibility of a catalyst.

The total amount of the cocatalyst compound supported on the carrier may be 2 to 15 mmol based on 1 g of the carrier. When the ratio of the cocatalyst compound and the carrier satisfies the above range, it is advantageous in terms of the activity maintenance of a catalyst and economic feasibility.

The carrier may be one or more than one type. For example, both the transition metal compound and the cocatalyst compound may be supported on one carrier, and each of the transition metal compound and the cocatalyst compound may be supported on two or more carriers. In addition, only one of the transition metal compound and the cocatalyst compound may be supported on the carrier.

As a method for supporting the transition metal compound and/or the cocatalyst compound which may be used in the catalyst for olefin polymerization, a physical adsorption method or a chemical adsorption method may be used.

For example, the physical adsorption method may be a method of bringing a solution in which a transition metal compound is dissolved into contact with a carrier and then drying, a method of bringing a solution in which a transition metal compound and a cocatalyst compound are dissolved into contact with a carrier and then drying, a method of bringing a solution in which a transition metal compound is dissolved into contact with a carrier and then drying to produce a carrier on which the transition metal compound is supported, separately bringing a solution in which a cocatalyst compound is dissolved into contact with a carrier and then drying to produce a carrier on which the cocatalyst compound is supported, and then mixing them, or the like.

The chemical adsorption method may be a method of first supporting a cocatalyst compound on the surface of a carrier and then supporting a transition metal compound on the cocatalyst compound, a method of binding a functional group (for example, in the case of silica, a hydroxyl group (—OH) on the surface of silica) on the surface of a carrier and a catalyst compound covalently.

In a specific example of the present invention, the olefin-based polymer may be polymerized by a polymerization reaction such as free radical, cationic, coordination, condensation, and addition polymerization, but is not limited thereto.

In an exemplary embodiment of the present invention, the olefin-based polymer may be produced by a gas phase polymerization method, a solution polymerization method, a slurry polymerization method, or the like. Preferably, the polymerization of the olefin-based monomer may be performed by gas phase polymerization, and specifically, the polymerization of the olefin-based monomer may be performed in a gas phase fluidized bed reactor.

When the olefin-based polymer is produced by a solution polymerization method or a slurry polymerization method, an example of the solvent to be used may include a C₅₋₁₂ aliphatic hydrocarbon solvent such as pentane, hexane, heptane, nonane, decane, and isomers thereof; an aromatic hydrocarbon solvent such as toluene and benzene; a hydrocarbon solvent substituted with a chlorine atom such as dichloromethane and chlorobenzene; and a mixture thereof, but is not limited thereto.

### Olefin-Based Polymer

According to an exemplary embodiment of the present invention, an olefin-based polymer which is produced by the above production method, and has (1) a density of 0.915 to 0.935 g/cm³; and (2) a melt index (MI_{2.16}) of 0.5 to 1.5 g/10 min as measured with a load of 2.16 kg at 190° C. is provided.

In a specific example of the present invention, the olefin-based polymer has a density of 0.915 to 0.935 g/cm³. Preferably, the olefin-based polymer may have a density of 0.915 to 0.925 g/cm³.

In a specific example of the present invention, the olefin-based polymer may have a melt index (MI_{2.16}) of 0.5 to 1.5 g/10 min as measured with a load of 2.16 kg at 190° C. Preferably, the olefin-based polymer may have a melt index of 0.8 to 1.2 g/10 min as measured with a load of 2.16 kg at 190° C.

In a specific example of the present invention, the olefin-based polymer may be a homopolymer of an olefin-based monomer or a copolymer of olefin-based monomer and comonomer. Preferably, the olefin-based polymer is a copolymer of an olefin-based monomer and an olefin-based comonomer.

Herein, the olefin-based monomer may be at least one selected from the group consisting of C₂₋₂₀ α-olefin, C₁₋₂₀ diolefin, C₃₋₂₀ cycloolefin, and C₃₋₂₀ cyclodiolefin.

For example, the olefin-based monomer may be ethylene, propylene, 1-butene, 1-pentene, 4-methyl-1-pentene, 1-hexene, 1-heptene, 1-octene, 1-decene, 1-undecene, 1-dodecene, 1-tetradecene, or 1-hexadecene, and the olefin-based polymer may be a homopolymer including only one or a copolymer including two or more of the olefin-based monomers exemplified above.

In an exemplary embodiment, the olefin-based polymer may be a copolymer of ethylene and C₃₋₂₀ α-olefin. Preferably, the olefin-based polymer may be a linear low-density polyethylene in which the olefin-based monomer is ethylene and the olefin-based comonomer is 1-hexene.

In this case, the content of ethylene is preferably 55 to 99.9 wt %, and more preferably 90 to 99.9 wt %. The content of the α-olefin-based comonomer is preferably 0.1 to 45 wt %, and more preferably 0.1 to 10 wt %.

In a specific example of the present invention, a film produced from the olefin-based polymer may have a drop impact strength (unit: g) satisfying the following Equation 2 as measured in accordance with ASTM D1709 based on a thickness of 50 μm:

$$- 1.8 {T}^{2} + 275 T - 9830 < drop impact strength < - 1.8 {T}^{2} + 275 T - 9730 \qquad [ Mathematical 2 ]$$

wherein T is a polymerization temperature (° C.)

Since the processability and the molecular distribution of the olefin-based polymer according to an exemplary embodiment of the present invention may be adjusted by a polymerization temperature, it is understood that the drop impact strength of a film produced therefrom may be also adjusted by the polymerization temperature.

In a specific example of the present invention, the olefin-based polymer film may be effectively used as a stretch film, an overlap film, a lamination, a silage warp, an agricultural film, and the like.

In a specific example of the present invention, a method for molding a film from the olefin-based polymer according to an exemplary embodiment of the present invention is not particularly limited, and a molding method known in the art to which the present invention belongs may be used. For example, the olefin-based polymer described above may be processed by a common method such as blown film molding, extrusion molding, or casting molding, thereby preparing an olefin-based polymer film. Among them, blown film molding is most preferred.

### BEST MODE FOR CARRYING OUT THE INVENTION

### Examples

### Preparation Example

The transition metal compound of Chemical Formula 1-2 (dimethylbis (n-propylcyclopentadienyl) hafnium dichloride) and the transition metal compound of Chemical Formula 3-1 ((pentamethylcyclopentadienyl) (n-propylcyclopentadienyl) zirconium dichloride) were purchased from MCN, and used without further purification.

### Preparation Example 1

892 g of a 10% toluene solution of methylaluminoxane was added to 4.07 g of the transition metal compound of Chemical Formula 1-2 and 1.68 g of the transition metal compound of Chemical Formula 3-1, and the solution was stirred at room temperature for 1 hour. The solution after the reaction was added to 200 g of silica (XPO-2402), 1.5 L of toluene was further added, and stirring was performed at 70° C. for 2 hours. The supported catalyst was washed three times using 500 mL of toluene, and was dried overnight at 60° C. under vacuum to obtain 280 g of a supported catalyst in a powder form.

### Examples 1 and 3

Ethylene/1-hexene copolymers were produced in the presence of the supported catalysts, which were obtained in Preparation Example 1, using a continuous gas phase fluidized bed reactor. The ethylene partial pressure of the reactor was maintained at about 15 kg/cm², and the polymerization temperature was maintained as shown in the following Table 1.

The polymerization conditions of the examples are shown in the following Table 1.

TABLE 1

| | Exam- | Exam- | Exam- |
|---|---|---|---|
| | ple 1 | ple 2 | ple 3 |
| Polymerization temperature (° C.) | 75 | 80 | 85 |
| Catalyst injection amount (g/h) | 2.3 | 2.1 | 2.1 |
| Hydrogen injection amount (g/h) | 2.22 | 2.13 | 2.19 |
| 1-Hexene injection amount (kg/h) | 1.57 | 1.54 | 1.49 |
| Hydrogen/ethylene concentration (%) ratio | 0.048 | 0.049 | 0.047 |
| 1-Hexene/ethylene concentration (%) ratio | 1.31 | 1.39 | 1.30 |
| Production amount per hour (kg/h) | 6.20 | 6.22 | 7.10 |

### Comparative Examples 1 to 3

Linear low-density polyethylene M1810 HN available from Hanwha Solutions was produced under the polymerization conditions as in Examples 1 to 3, respectively, for comparison.

### Test Example

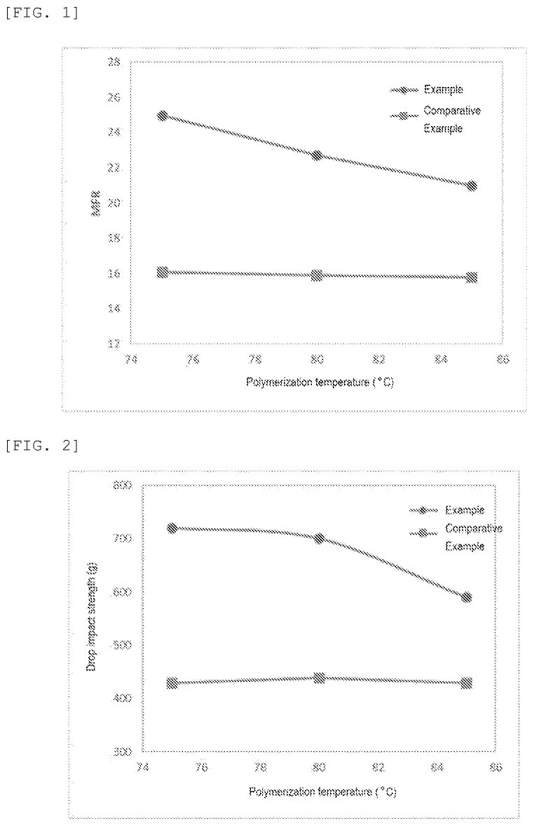

The physical properties of the olefin-based polymers of the above examples were measured by the following methods and criteria. The results are shown in the following Table 2 and FIGS. 1 and 2.

### (1) Density

Measured according to ASTM D 1505.

### (2) Melt Index and Melt Index Ratio (MFR)

The melt index was measured with a load of 21.6 kg and a load of 2.16 kg, respectively, at 190° C. in accordance with ASTM D1238, and the ratio (MI_{21.6}/MI_{2.16}) was calculated.

### (3) Drop Impact Strength

Each of the resins of the examples and the comparative examples was produced into a film having a thickness of 50 μm through a 40 mm blown film extruder (40 mm (screw, 75 mm (die, 2 mm die gap). At this time, the extrusion conditions were fixed to C1/C2/C3/A/D1/D2=160/165/170/175/180/180° C., a screw speed of 60 rpm, and a blow-up ratio (BUR) of 2.

The drop impact strength of the produced film was measured in accordance with the method of ASTM D1709 (B) in which a film having a thickness of 50 μm was fixed and a weight having a diameter of 38.10±0.13 mm was dropped from a height of 0.66±0.01 m.

TABLE 2

| | | | | | Comparative | Comparative | Comparative |
|---|---|---|---|---|---|---|---|
| | Unit | Example 1 | Example 2 | Example 3 | Example 1 | Example 2 | Example 3 |
| Density | g/cm³ | 0.9181 | 0.9179 | 0.9182 | 0.9180 | 0.9183 | 0.9181 |
| MI_{2.16} | g/10 min | 1.01 | 1.03 | 0.98 | 1.01 | 1.00 | 1.03 |
| MI_{21.6} | g/10 min | 25.3 | 23.4 | 20.6 | 16.3 | 15.9 | 16.5 |
| MFR | — | 25.0 | 22.7 | 21.0 | 16.1 | 15.9 | 16.0 |
| Drop impact | g | 720 | 700 | 590 | 430 | 440 | 430 |
| strength | | | | | | | |

### INDUSTRIAL APPLICABILITY

As confirmed from Table 2 and FIGS. 1 and 2, the method for preparing an olefin-based polymer according to the exemplary embodiment of the present invention may adjust processability of an olefin-based polymer produced using the method by a polymerization temperature. In addition, the method for preparing an olefin-based polymer according to the exemplary embodiment of the present invention may adjust drop impact strength of a finally obtained film by a polymerization temperature.

1. A method for preparing an olefin-based polymer, the method comprising: polymerizing an olefin-based monomer at a polymerization temperature of 70 to 90° C. in the presence of a hybrid catalyst including at least one first transition metal compound represented by the following Chemical Formula 1 and at least one second transition metal compound selected from a compound represented by the following Chemical Formula 2 and a compound represented by the following Chemical Formula 3, thereby obtaining an olefin-based polymer, wherein the olefin-based polymer has (1) a density of 0.915 to 0.935 g/cm³; (2) a melt index (MI_{2.16}) of 0.5 to 1.5 g/10 min as measured with a load of 2.16 kg at 190° C.; and (3) a ratio (melt flow ratio; MFR) between a melt index (MI_{21.6}) measured with a load of 21.6 kg and a melt index (MI_{2.16}) measured with a load of 2.16 kg at 190° C. satisfying the following Equation 1:
$$- 0.4 T + 53.7 < MFR < - 0.4 T + 55.7 \qquad [ Equation 1 ]$$ 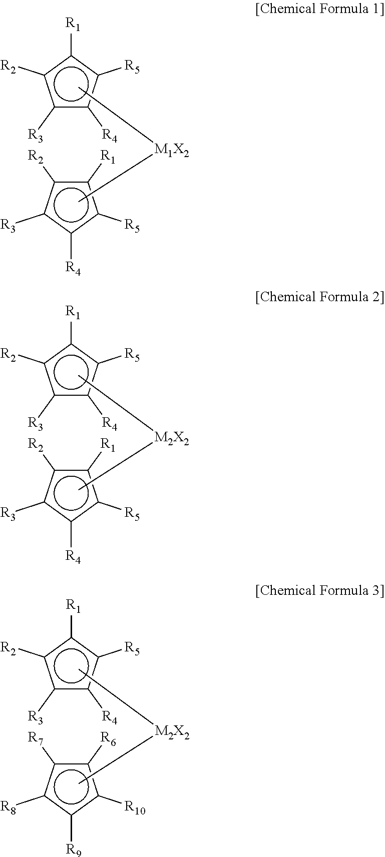
wherein MFR is a melt flow ratio, T is a polymerization temperature (° C.),
M₁ and M₂ are different from each other and independently of each other titanium (Ti), zirconium (Zr), or hafnium (Hf),
X is independently of each other halogen, C₁₋₂₀ alkyl, C₂₋₂₀ alkenyl, C₂₋₂₀ alkynyl, C₆₋₂₀ aryl, C₁₋₂₀ alkyl C₆₋₂₀ aryl, C₆₋₂₀ aryl C₁₋₂₀ alkyl, C₁₋₂₀ alkylamido, or C₆₋₂₀ arylamido, and
R₁ to R₁₀ are independently of one another hydrogen, substituted or unsubstituted C₁₋₂₀ alkyl, substituted or unsubstituted C₂₋₂₀ alkenyl, substituted or unsubstituted C₆₋₂₀ aryl, substituted or unsubstituted C₁₋₂₀ alkyl C₆₋₂₀ aryl, substituted or unsubstituted C₆₋₂₀ aryl C₁₋₂₀ alkyl, substituted or unsubstituted C₁₋₂₀ heteroalkyl, substituted or unsubstituted C₃₋₂₀ heteroaryl, substituted or unsubstituted C₁₋₂₀ alkylamido, substituted or unsubstituted C₆₋₂₀ arylamido, substituted or unsubstituted C₁₋₂₀ alkylidene, or substituted or unsubstituted C₁₋₂₀ silyl, but R₁ to R₁₀ may be independently of one another connected to an adjacent group to form a substituted or unsubstituted saturated or unsaturated C₄₋₂₀ ring.

2. The method for preparing an olefin-based polymer of claim 1, wherein M₁ and M₂ are different from each other and are zirconium or hafnium, respectively, X is halogen or C₁₋₂₀ alkyl, respectively, and R₁ to R₁₀ are hydrogen, substituted or unsubstituted C₁₋₂₀ alkyl, substituted or unsubstituted C₂₋₂₀ alkenyl, or substituted or unsubstituted C₆₋₂₀ aryl, respectively.

3. The method for preparing an olefin-based polymer of claim 2, wherein M₁ is hafnium, M₂ is zirconium, and X is chlorine or methyl.

4. The method for preparing an olefin-based polymer of claim 1, wherein the first transition metal compound is at least one of transition metal compounds represented by the following Chemical Formulae 1-1 and 1-2, and the second transition metal compound is at least one of transition metal compounds represented by the following Chemical Formulae 2-1, 2-2, and 3-1: 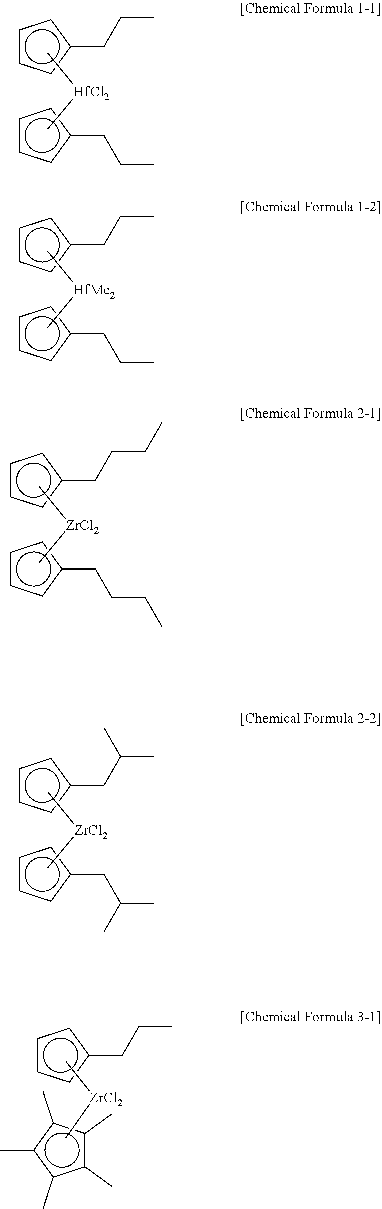
wherein Me is a methyl group.

5. The method for preparing an olefin-based polymer of claim 1, wherein a mole ratio of the first transition metal compound to the second transition metal compound is in a range of 100:1 to 1:100.

6. The method for preparing an olefin-based polymer of claim 1, wherein the catalyst further includes at least one cocatalyst compound selected from the group consisting of a compound represented by the following Chemical Formula 4, a compound represented by the following Chemical Formula 5, and a compound represented by the following Chemical Formula 6: 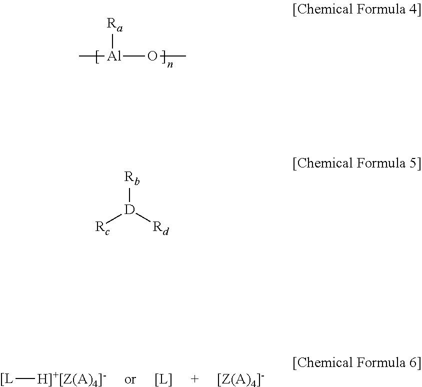
wherein n is an integer of 2 or more, Rₐ is a halogen atom, a C₁₋₂₀ hydrocarbon group, or a C₁₋₂₀ hydrocarbon group substituted with halogen,
D is aluminum (Al) or boron (B), R_{b}, R_{c}, and R_{d} are independently of one another a halogen atom, a C₁₋₂₀ hydrocarbon group, a C₁₋₂₀ hydrocarbon group substituted with halogen, or a C₁₋₂₀ alkoxy group,
L is a neutral or cationic Lewis base, [L-H]⁺ and [L]⁺ are a Bronsted acid, Z is a group 13 element, and A is independently of each other a substituted or unsubstituted C₆₋₂₀ aryl group or a substituted or unsubstituted C₁₋₂₀ alkyl group.

7. The method for preparing an olefin-based polymer of claim 6, wherein the catalyst further comprises a carrier which supports the transition metal compound, the cocatalyst compound, or both of them.

8. The method for preparing an olefin-based polymer of claim 7, wherein the carrier comprises at least one selected from the group consisting of silica, alumina, and magnesia.

9. The method for preparing an olefin-based polymer of claim 7, wherein a total amount of the transition metal compound supported on the carrier is 0.001 to 1 mmol based on 1 g of the carrier, and a total amount of the cocatalyst compound supported on the carrier is 2 to 15 mmol based on 1 g of the carrier.

10. The method for preparing an olefin-based polymer of claim 1, wherein the olefin-based polymer is a copolymer of the olefin-based monomer and an olefin-based comonomer.

11. The method for preparing an olefin-based polymer of claim 10, wherein the olefin-based monomer is ethylene, and the olefin-based comonomer is one or more selected from the group consisting of propylene, 1-butene, 1-pentene, 4-methyl-1-pentene, 1-hexene, 1-heptene, 1-octene, 1-decene, 1-undecene, 1-dodecene, 1-tetradecene, and 1-hexadecene.

12. The method for preparing an olefin-based polymer of claim 11, wherein the olefin-based polymer is a linear low-density polyethylene in which the olefin-based monomer is ethylene and the olefin-based comonomer is 1-hexene.

13. The method for preparing an olefin-based polymer of claim 1, wherein polymerization of the olefin-based monomer is gas phase polymerization.

14. An olefin-based polymer which is produced by the method for preparing an olefin-based polymer of claim 1 and has (1) a density of 0.915 to 0.935 g/cm³ and (2) a melt index (MI_{2.16}) of 0.5 to 1.5 g/10 min as measured with a load of 2.16 kg at 190° C.

15. The olefin-based polymer of claim 14, wherein the olefin-based polymer has (1) the density of 0.915 to 0.925 g/cm³ and (2) the melt index of 0.8 to 1.2 g/10 min as measured with a load of 2.16 kg at 190° C.

16. The olefin-based polymer of claim 14, wherein a film produced from the olefin-based polymer has a drop impact strength (unit: g) satisfying the following Equation 2 as measured in accordance with ASTM D1709 based on a thickness of 50 μm:
$$- 1.8 {T}^{2} + 275 T - 9830 < drop impact strength < - 1.8 {T}^{2} + 275 T - 9730 \qquad [ Equation 2 ]$$
wherein T is a polymerization temperature (° C.)
